(19) United States
(12) Patent Application Publication
(10) Pub. No.: US 2023/0143517 A1
(43) Pub. Date: May 11, 2023

(54) VEGETABLE NOODLE FOOD PRODUCTS

(71) Applicant: Forward Thinking Group LLC, Greenwich, CT (US)

(72) Inventor: Moganakkumar Anthony, Greenwich, CT (US)

(21) Appl. No.: 17/522,984

(22) Filed: Nov. 10, 2021

(51) Int. Cl. A23L 19/00; A23L 3/44

(52) U.S. Cl. CPC A23L 19/03; A23L 3/44; A23V 2002/00

(57) ABSTRACT

Described herein are example of vegetable noodle food products and methods of making the same. A method may include washing a raw vegetable, slicing the raw vegetable into a vegetable sheet, rolling the vegetable sheet into a vegetable roll, slicing the vegetable roll across a longitudinal axis of the vegetable roll into a plurality of spiral vegetable noodles, drying the spiral vegetable noodles using a dryer to yield dried spiral vegetable noodles, arranging the dried spiral vegetable noodles in a container, and sealing the container. A food product may include a container and a plurality of freeze-dried spiral vegetable noodles disposed in the container. A method may include slicing a raw vegetable into a vegetable sheet, rolling the vegetable sheet into a vegetable roll, slicing the vegetable roll across a longitudinal axis of the vegetable roll to yield a spiral vegetable noodle, and drying the spiral vegetable noodle.

### BACKGROUND

Ready-to-go meals may be a convenient solution for people seeking a meal. Many people may have gluten sensitivities, may not be able to tolerate gluten, or may otherwise choose to avoid eating gluten for various reasons, which may be related to health or other personal reasons. Additionally, for health, fitness, or other reasons, people may be conscious of consumption of carbohydrates, preservatives, or other food additives.

### BRIEF DESCRIPTION OF THE DRAWINGS

The present description will be understood more fully when viewed in conjunction with the accompanying drawings of various examples of vegetable noodle food products. The description is not meant to limit the vegetable noodle food products to the specific examples. Rather, the specific examples depicted and described are provided for explanation and understanding of vegetable noodle food products. Throughout the description the drawings may be referred to as drawings, figures, and/or FIGs.

FIG. 1 illustrates a cup of noodles with a seasoning sachet, according to an embodiment.

FIG. 2 illustrates a method of making noodles, according to an embodiment.

FIG. 3 illustrates a method of making a noodle, according to an embodiment.

FIG. 4 illustrates a vegetable being sliced using a slicer, according to an embodiment.

FIG. 5 illustrates a vegetable roll, according to an embodiment.

FIG. 6 illustrates spiral vegetable noodles, according to an embodiment.

FIG. 7 illustrates a spiral vegetable noodle placed on a tray, according to an embodiment.

### DETAILED DESCRIPTION

Vegetable noodle food products as disclosed herein will become better understood through a review of the following detailed description in conjunction with the figures. The detailed description and figures provide merely examples of the various embodiments of vegetable noodle food products. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional ready-to-go meal may include a cup of ramen noodle soup. In such meals, dried ramen noodles may be stored in a heat-resistant cup. To prepare for eating, the ramen noodles may be reconstituted, (i.e., softened) using hot water. Generally, a preparer of dried ramen noodles may add hot water to the cup and wait for the noodles to soften, add cold water to the cup and then heat the water and noodles, or pour the dried noodles from the to-go cup into a container containing hot water. Once the noodles are softened by the hot water, spices may be added to the hot water and noodles to finish making a cup of noodle soup.

Ramen noodles are generally not gluten free, which may present problems for people with gluten sensitives. Other people may choose to avoid eating gluten for various health-related reasons.

Some vegetable-based noodles have been produced to attempt a gluten-free option. Some have included adding a saccharide prior to vegetables prior to their formation into noodles or compressing the vegetables prior to drying. However, conventional methods of producing dried vegetable noodles may produce brittle noodles, may not reconstitute to a noodle shape, and may be over-softened with an unappealing texture when reconstituted. The brittleness of such dried noodles may further lead to small pieces of reconstituted vegetable floating within a resultant soup rather than a clear soup with noodles. In addition to degraded physical characteristics, a nutritional value of conventionally-dried noodles may be attenuated due to the introduction of a saccharide or compression during drying.

Conventional vegetable-based noodles can be affected by a substantial loss of nutritional value during the process of drying. Cell damage is a major culprit, and this may result from inefficiencies within the drying process. In conventional processes for making vegetable noodles, the noodles may be cut into a rod or undulating shape and laid out on a tray or rack to be dried. During the drying process, the sublimation of the water may be inefficient due to insufficient surface area, which may result in some of the sublimated vapor being trapped within the cells of the noodle, thus the melting of ice formed within the cells during the freezing process. This increase in pressure due to the sublimated vapor remaining within the cell may cause cell breakdowns, which may result in substantial nutrient loss and cracked or embrittled noodles.

Further, the shelf life of existing fresh or insufficiently dried vegetable-based noodles may be short as they may be susceptible to bacterial growth, for example, of coliform.

Implementations of vegetable noodle food products may address some or all of the problems described above. Vegetable noodle food products may include gluten-free vegetable noodles, which may be freeze dried and, for example, stored in a to-go cup. The vegetable noodles may be made by forming a vegetable into a vegetable sheet, rolling the vegetable sheet into a vegetable roll, cutting the vegetable roll into one or more spiral vegetable noodles, and drying the spiral vegetable noodles.

With a spiral shape, the spiral vegetable noodles may not need to be manipulated or deformed for placement into a container (e.g., a to-go cup), which may reduce or eliminate small pieces breaking off when packaging the spiral vegetable noodles, thereby enabling the production of soup with minimal or without floating non-noodle vegetable pieces upon reconstitution. Further, the vegetable noodles may retain their spiral form upon reconstitution.

Having a spiral shape, the spiral vegetable noodles as embodied herein may provide a greater exposed surface area than conventional noodles. This greater surface area provides for greater ability for sublimated water vapor to exit the noodles during the heating portion of the freeze-drying process. With more water vapor escaping, the cells of the spiral vegetable noodle are less susceptible to breakdown, and thus the noodle itself may better retain its shape without cracking and may be less embrittled than conventional noodles. Further, without substantial cell breakdown that can allow nutrients to escape, the spiral shape of the noodles herein may provide for greater retention of nutritional value than conventional implementations. Additionally, with less susceptibility to cell breakdown, upon reconstitution, the spiral vegetable noodles may more substantially retain their shape.

The vegetable noodles may be reconstituted (e.g., using hot water) while retaining their taste, noodle shape, desirable consistency and texture, and high nutritional value without added preservatives. Without becoming water-logged or mushy upon reconstitution, broths and sauces may adhere well to the vegetable noodles. The spiral shape of the vegetable noodles may provide for greater durability during packaging and handling, as well as portion control. The vegetable noodles may have an extended shelf life (e.g., due do a lower susceptibility to bacterial growth). Since the noodles may include vegetables, they may be gluten free. Vegetable noodles herein may further cook and reconstitute faster (e.g., needing 1-2 minutes in a microwave rather than 3-4 minutes).

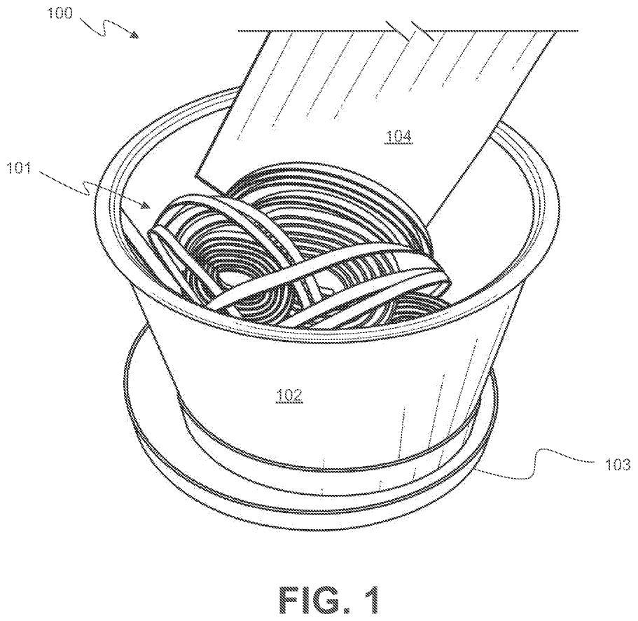

FIG. 1 illustrates a vegetable noodle food product 100 with a seasoning sachet 104, according to an embodiment. The vegetable noodle food product 100 may provide for an easy-to-prepare, gluten-free meal with a long shelf life. The vegetable noodle food product 100 may be prepared using, for example, a microwave or stove.

The food product 100 may include a plurality of freeze-dried spiral vegetable noodles 101, which may be disposed in a container 102. Each freeze-dried spiral vegetable noodle may be configured to retain a spiral shape. Each freeze-dried spiral vegetable noodle may include one or more vegetable noodle coils. Each coil may be substantially circular, forming multiple substantially concentric convolutions of the vegetable noodle. Each freeze-dried spiral vegetable noodle substantially may retain a nutritional value. At least one of the freeze-dried spiral vegetable noodles has a substantially circular, rectangular, elliptical, or oval cross-sectional shape.

The container 102 may have a lid 103 configured to attach to an open top of the container 102 or act as a stand or table mat therefor.

At least one of the freeze-dried spiral vegetable noodles 101 may have a longitudinal thickness of approximately 1 mm (e.g., capellini noodles), approximately 1.5 mm (e.g., angel hair noodles), approximately 2 mm (e.g., ramen or spaghetti noodles), approximately 4 mm (e.g., fettuccine or trenette noodles), or approximately 6.35 mm (e.g., wider fettuccine noodles).

At least one of the freeze-dried spiral vegetable noodles 101 may have a radial noodle thickness of approximately 0.8 mm or another noodle thickness, which may depend on the vegetable used.

At least one of the freeze-dried spiral vegetable noodles 101 may include a portion of a carrot, a daikon, a parsnip, a zucchini, a yellow squash, a turnip, a beet, a butternut squash, a rutabaga, a zucchini, a cucumber, a broccoli stalk, a cauliflower stalk, a potato, a pumpkin, or another root vegetable, vegetable stalk, or cruciferous plant or fruit.

A sachet 104 may be disposed within the container 102. The sachet 104 may contain, for example, a salt, a seasoning, a blend of seasonings, or vegetable fragments. The sachet 104 may include a bag, which may be configured to be torn or cut open, or otherwise opened, to empty some or all of its contents into, for example, the container 102.

The container 102 may include a paper or a plastic (e.g., ABS, polylactic acid (PLA), polycarbonate (PG), polyethylene terephthalate (PET, PETT, PETG, PETE), nylon, high density polyethylene (HDPE), polyvinyl chloride (PVC), low density polyethylene (LDPE), polypropylene (PP), or polystyrene, or other suitable plastics).

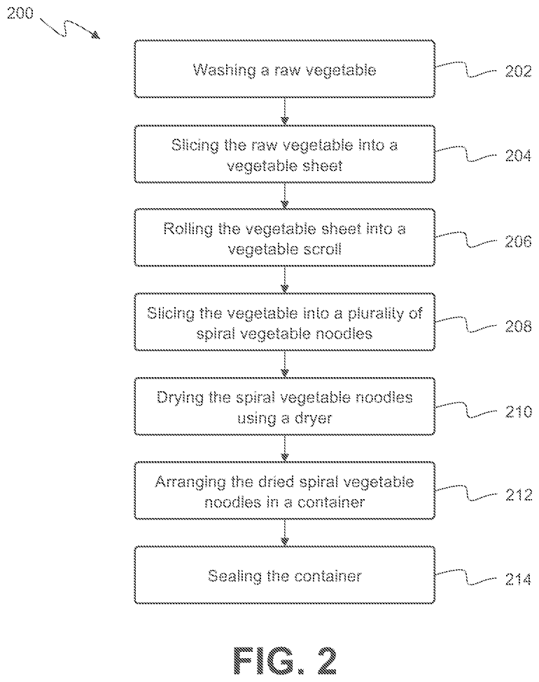

FIG. 2 illustrates a method 200 of making a vegetable noodle food product, according to an embodiment. The method 200 may produce an easy-to-prepare meal.

The method 200 may include, at 202, washing a raw vegetable. Washing the vegetable at 202 may remove all or a substantial amount of debris, bacteria (e.g., coliform), pesticide, or other contaminants. Washing the raw vegetable may include spraying the raw vegetable using a high-pressure water sprayer.

Prior to washing the raw vegetable at 202, a skin of the raw vegetable may be peeled off of the raw vegetable.

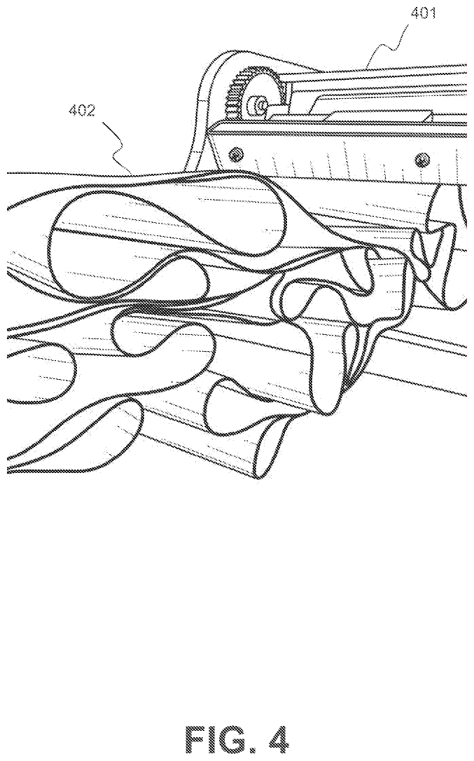

The method 200 may further include, at 204, slicing the raw vegetable into a vegetable sheet. The raw vegetable may be sliced into a vegetable sheet using, for example a sheet cutter (as seen in, for example, FIG. 4).

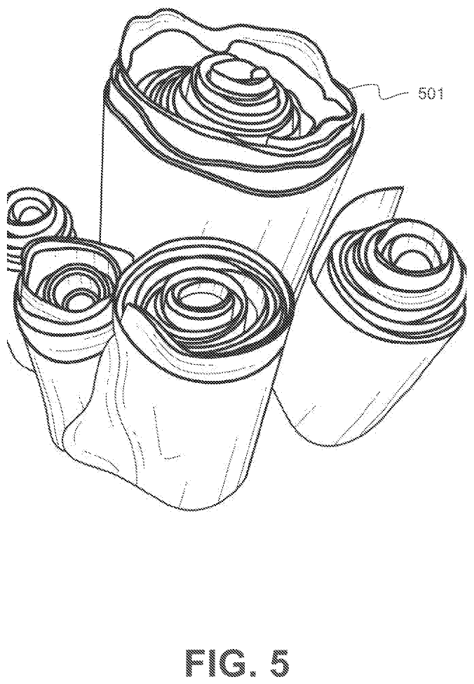

The method 200 may further include, at 206, rolling the vegetable sheet into a vegetable roll, which may resemble a cylindrical shape (as seen in, for example, FIG. 5). The vegetable roll may include one or more vegetable sheet convolutions, where the convolutions are substantially circular and substantially concentric. Each convolution may be tightly rolled, for instance, the convolution may have a surface interface with at least one other convolution. The vegetable sheet may be rolled such that the vegetable roll is tightly rolled. Tightly rolling the vegetable sheet may involve rolling the vegetable sheet such that an internal tension within the vegetable sheet is less than a breaking tension at which the vegetable sheet would break. For example, the roll may be wound to within a 1 mm tightness such that the length of the noodle may be calculated by how many rotations the vegetable roll may have.

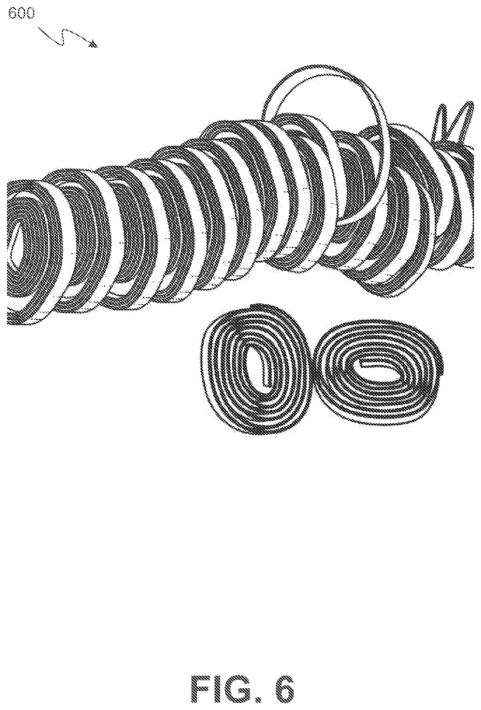

The method 200 may further include, at 208, slicing the vegetable roll across a longitudinal axis of the vegetable roll into a plurality of spiral vegetable noodles (as seen in, for example, FIG. 6). The spiral vegetable noodle may include one or more vegetable noodle coils. Each vegetable noodle coil may be substantially circular, and substantially concentric to any other vegetable noodle coil in the vegetable noodle coil. Vegetable noodles may be cut into different desired thicknesses to create, for example, fettuccine noodles, spaghetti noodles, or linguine noodles. The vegetable noodles may be cut to, for example, a thickness of approximately 1 mm (e.g., capellini noodles) approximately 1.5 mm (e.g., angel hair noodles), approximately 2 mm (e.g., ramen or spaghetti noodles), approximately 4 mm (e.g., fettuccine or trenette noodles), or approximately 6.35 mm (e.g., wider fettuccine noodles). The vegetable noodles may be cut using, for example, blade-based cutting tools or water jets.

The method 200 may further include, at 210, drying the spiral vegetable noodles using a dryer to yield dried spiral vegetable noodles. Drying the spiral vegetable noodles may be performed such that a nutritional value of the spiral vegetable noodles is substantially retained through the drying process. The spiral vegetable noodles may further retain their physical shape during the drying process and not be substantially embrittled and break, thus remaining substantially intact during the drying step.

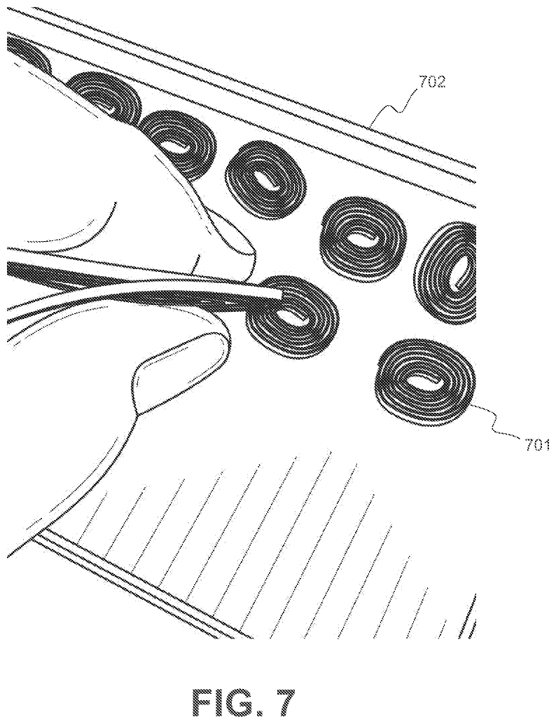

Prior to drying the spiral vegetable noodles, the spiral vegetable noodles may be placed on a tray (as seen in, for example, FIG. 7), which may be configured to fit within the dryer.

The dryer may include a freeze dryer, a dehydrator, a slow dryer, an oven, a sun dryer, or a fryer.

In an embodiment, the dryer may include a freeze dryer. Freeze drying involves a removal of water from a frozen product using a process called sublimation, which may occur when a frozen liquid transforms directly to a gaseous state without passing back through a liquid phase. Generally, freeze drying may include prefreezing, primary drying, and secondary drying. Freeze drying the vegetable noodles may improve nutrient, aroma, flavor, taste, and physical structure retention. Further, freeze drying a food may alleviate a need to refrigerate or add preservatives to the food to preserve it.

Drying the spiral vegetable noodles may include adjusting the freeze dryer to a cooling temperature, thereby freezing the spiral vegetable noodles, and adjusting the freeze dryer to heat over an evaporating time to an evaporation temperature, thereby heating the spiral vegetable noodles.

The evaporating time may be determined such that a moisture content of the spiral vegetable noodles may be reduced to at most 5%.

The evaporating time may be 12 hours. The cooling temperature may be −4 degrees Fahrenheit. The evaporation temperature may be 156 degrees Fahrenheit. A moisture content of the dried spiral vegetable noodles may be verified to be at most 5%.

The method 200 may further include, at 212, arranging the dried spiral vegetable noodles in a container.

A seasoning sachet may be arranged in the container. The seasoning sachet may contain, for example, a salt, a seasoning, a blend of seasonings, or vegetable fragments. The sachet 104 may include a bag, which may be configured to be torn or cut open, or otherwise opened, to empty some or all of its contents into, for example, the container.

The method 200 may further include, at 214, sealing the container. The seal of the container may be formed using, for example, a shrink-fit or an adhesive.

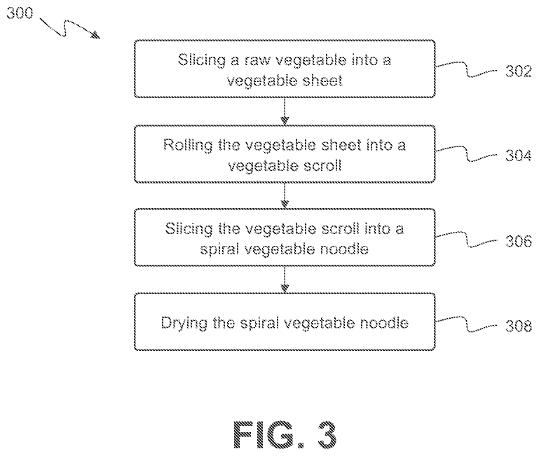

FIG. 3 illustrates a method 300 of making a vegetable noodle, according to an embodiment. The method 300 may produce a noodle, which can form part of an easy-to-prepare meal.

The method 300 may include, at 302, slicing a raw vegetable into a vegetable sheet.

The method 300 may include, at 304, rolling the vegetable sheet into a vegetable roll. The vegetable roll may include one or more vegetable sheet convolutions, where the convolutions are substantially circular and substantially concentric. Each convolution may be tightly rolled, for instance, the convolution may have a surface interface with at least one other convolution. The vegetable sheet may be rolled such that the vegetable roll is tightly rolled. Tightly rolling the vegetable sheet may involve rolling the vegetable sheet such that an internal tension within the vegetable sheet is less than a breaking tension at which the vegetable sheet would break. For example, the roll may be wound to within a 1 mm tightness such that the length of the noodle may be calculated by how many rotations the vegetable roll may have.

The method 300 may include, at 306, slicing the vegetable roll across a longitudinal axis of the vegetable roll to yield a spiral vegetable noodle. The spiral vegetable noodle may include one or more vegetable noodle coils. Each vegetable noodle coil may be substantially circular, and substantially concentric to any other vegetable noodle coil in the vegetable noodle coil.

The method 300 may include, at 308, drying the spiral vegetable noodle. Drying the spiral vegetable noodles may be performed such that a nutritional value of the spiral vegetable noodles is substantially retained through the drying process. The spiral vegetable noodles may further retain their physical shape during the drying process and not be substantially embrittled and break, thus remaining substantially intact during the drying step.

The spiral vegetable noodle may be arranged with other spiral noodles in a container, which may include a seasoning sachet.

FIG. 4 illustrates a vegetable being sliced using a slicer 401, according to an embodiment. Slicing the vegetable using a slicer 401 may provide a vegetable sheet 402, which can be rolled into a vegetable roll which can later be cut to form spiral vegetable noodles.

For example, the slicer 401 may be a sheet cutter. A sheet cutter is a cutting device used to cut a continuous circumferential slice of an object, thus yielding a single slice in the form of a sheet such as the vegetable sheet 402. A setting of the slicer 401 may be used to control the thickness and width of the resulting vegetable sheet. For example, a sheet thickness may be 0.8 mm and may have a width of 120 mm. The thickness of the vegetable sheet 402 may determine the final thickness of the noodles of and produced according to embodiments of the present disclosure.

FIG. 5 illustrates a vegetable roll 501, according to an embodiment. The vegetable roll 501 may be used to efficiently produce spiral vegetable noodles by cutting across its longitudinal axis.

The vegetable roll 501 may be cylinder-like in shape. The cylinder-like shape of the vegetable roll 501 may provide for maximized surface area of the cut spiral vegetable noodles and for control of the length and width of the cut spiral vegetable noodles. The length of the cut spiral vegetable noodle may in this way directly correlate to the number of rotations of the vegetable roll 501.

FIG. 6 illustrates spiral vegetable noodles 600, according to an embodiment. The spiral vegetable noodles 600 may provide for uniformly-cross-sectioned noodles which may be easily dried, manipulated, and packaged.

For example, spiral vegetable noodles 600 may include fettuccine-type noodles, with one or more having a longitudinal thickness (i.e., a noodle width) of approximately 4 mm. The longitudinal thickness of one or more of the spiral vegetable noodles 600 may be understood as width of the spiral vegetable noodle slices as measured substantially parallel to the longitudinal axis of the vegetable roll the noodles were cut from. For example, one or more of the spiral vegetable noodles 600 may have a longitudinal thickness of approximately 1 mm (e.g., capellini noodles), approximately 1.5 mm (e.g., angel hair noodles), approximately 2 mm (e.g., ramen or spaghetti noodles), approximately 4 mm (e.g., fettuccine or trenette noodles), or approximately 6.35 mm (e.g., wider fettuccine noodles). A single vegetable roll may be cut into spiral vegetable noodles of varying widths.

FIG. 7 illustrates a spiral vegetable noodle 701 placed on a tray 702, according to an embodiment. Placing the spiral vegetable noodle 701 on a tray may provide for inserting the noodle on the tray into the freeze dryer and may provide a flat surface for the noodle to rest on to substantially retain its shape through the freeze drying process.

For example, spiral vegetable noodles 701 may include capellini-type noodles, one or more having a noodle width of approximately 1 mm.

Various types of spiral vegetable noodles can be made according to embodiments of the present disclosure.

As an example, a vegetable ramen noodle may be made from a white turnip. In this example method, the turnip may be washed and peeled by washing the vegetable using a water source (e.g., a high-pressure sprayer) for 1 minute to remove any remaining substantial debris, wax coating, or bacteria (e.g., coliform) and peeling using a stainless steel peeler. The vegetable may then be placed on a horizontal spindle of a sheet cutter, and while turning, may be cut using an agitated blade (e.g., a vegetable turning slicer with the crocheted with of 120 mm and a maximum diameter of 100 mm) into a continuous vegetable sheet having a thickness of 0.8 mm and respooled on an adjacent spindle. The respooling (e.g., over 10 full rotations) may leave no gaps between layers. The cylinder may then be cut at 2 mm longitudinal increments, yielding spiral vegetable noodles having a longitudinal thickness of 2 mm, a radial thickness of 0.8 mm, and a length of approximately 1 foot or less. The spiral vegetable noodles may be laid horizontally on appropriate trays, without overlapping. The trays of noodles may be placed in a freeze dryer for 12 hours using a cooling temperature of −4 deg Fahrenheit and an evaporating temperature of 156 deg Fahrenheit. The completed dried spiral vegetable noodles may have less than a 5% moisture content, which may then be placed into a 3.5 oz heat-resistant containers.

As a further example, linguine noodles may be made out of a yellow turnip using a similar method to the previously disclosed example of ramen noodle formation. However, for linguine, the cylinders may be cut at 4 mm longitudinal width increments using, for example a 9″ French knife).

As a further example, spaghetti noodles may be made out of a butternut squash. In this example method, the butternut squash vegetable may be washed and peeled by washing the vegetable using a water source (e.g., a high-pressure sprayer) for 1 minute to remove any remaining substantial debris, wax coating, or bacteria (e.g., coliform) and peeling using a stainless steel peeler. The vegetable may then be placed on a horizontal spindle of a sheet cutter, and while turning, may be cut using an agitated blade (e.g., a vegetable turning slicer with the crocheted with of 120 mm and a maximum diameter of 100 mm) into a continuous vegetable sheet having a thickness of 0.8 mm and respooled on an adjacent spindle. The respooling (e.g., over 10 full rotations) may leave no gaps between layers. The cylinder may then be cut at 2 mm longitudinal increments, yielding spiral vegetable noodles having a longitudinal thickness of 2 mm, a radial thickness of 0.8 mm, and a length of approximately 1 foot or less. The spiral vegetable noodles may be laid horizontally on appropriate trays, without overlapping. The trays of noodles may be placed in a freeze dryer for 12 hours using a cooling temperature of −4 deg Fahrenheit and an evaporating temperature of 156 deg Fahrenheit. The completed dried spiral vegetable noodles may have less than a 5% moisture content, which may then be placed into a 3.5 oz heat-resistant containers.

As a further example, fettuccine may be made using a daikon. In this example method, the daikon vegetable may be washed and peeled by washing the vegetable using a water source (e.g., a high-pressure sprayer) for 1 minute to remove any remaining substantial debris, wax coating, or bacteria (e.g., coliform) and peeling using a stainless steel peeler. The vegetable may then be placed on a horizontal spindle of a sheet cutter, and while turning, may be cut using an agitated blade (e.g., a vegetable turning slicer with the crocheted with of 120 mm and a maximum diameter of 100 mm) into a continuous vegetable sheet having a thickness of 0.8 mm and respooled on an adjacent spindle. The respooling (e.g., over 10 full rotations) may leave no gaps between layers. The cylinder may then be cut at 6.35 mm longitudinal increments, yielding spiral vegetable noodles having a longitudinal thickness of 6.35 mm, a radial thickness of 0.8 mm, and a length of approximately 1 foot or less. The spiral vegetable noodles may be laid horizontally on appropriate trays, without overlapping. The trays of noodles may be placed in a freeze dryer for 12 hours using a cooling temperature of −4 deg Fahrenheit and an evaporating temperature of 156 deg Fahrenheit. The completed dried spiral vegetable noodles may have less than a 5% moisture content, which may then be placed into a 3.5 oz heat-resistant containers.

As a further example, angel hair may be made using a carrot. In this example method, the carrot vegetable may be washed and peeled by washing the vegetable using a water source (e.g., a high-pressure sprayer) for 1 minute to remove any remaining substantial debris, wax coating, or bacteria (e.g., coliform) and peeling using a stainless steel peeler. The vegetable may then be placed on a horizontal spindle of a sheet cutter, and while turning, may be cut using an agitated blade (e.g., a vegetable turning slicer with the crocheted with of 120 mm and a maximum diameter of 100 mm) into a continuous vegetable sheet having a thickness of 0.8 mm and respooled on an adjacent spindle. The respooling (e.g., over 10 full rotations) may leave no gaps between layers. The cylinder may then be cut at 1.5 mm longitudinal increments, yielding spiral vegetable noodles having a longitudinal thickness of 1.5 mm, a radial thickness of 0.8 mm, and a length of approximately 1 foot or less. The spiral vegetable noodles may be laid horizontally on appropriate trays, without overlapping. The trays of noodles may be placed in a freeze dryer for 12 hours using a cooling temperature of −4 deg Fahrenheit and an evaporating temperature of 156 deg Fahrenheit. The completed dried spiral vegetable noodles may have less than a 5% moisture content, which may then be placed into a 3.5 oz heat-resistant containers.

As a further example, trenette may be made using a zucchini. In this example method, the zucchini vegetable may be washed and peeled by washing the vegetable using a water source (e.g., a high-pressure sprayer) for 1 minute to remove any remaining substantial debris, wax coating, or bacteria (e.g., coliform) and peeling using a stainless steel peeler. The vegetable may then be placed on a horizontal spindle of a sheet cutter, and while turning, may be cut using an agitated blade (e.g., a vegetable turning slicer with the crocheted with of 120 mm and a maximum diameter of 100 mm) into a continuous vegetable sheet having a thickness of 0.8 mm and respooled on an adjacent spindle. The respooling (e.g., over 10 full rotations) may leave no gaps between layers. The cylinder may then be cut at 4 mm longitudinal increments, yielding spiral vegetable noodles having a longitudinal thickness of 4 mm, a radial thickness of 0.8 mm, and a length of approximately 1 foot or less. The spiral vegetable noodles may be laid horizontally on appropriate trays, without overlapping. The trays of noodles may be placed in a freeze dryer for 12 hours using a cooling temperature of −4 deg Fahrenheit and an evaporating temperature of 156 deg Fahrenheit. The completed dried spiral vegetable noodles may have less than a 5% moisture content, which may then be placed into a 3.5 oz heat-resistant containers.

As a further example, dried spiral vegetable noodles may be placed (e.g., arranged) in a container (e.g., a 3.5 oz heat-resistant container). Spices may be placed into the container, either directly or within a sachet. The container may be sealed with a lid or a plastic or paper cover.

In some examples, the product may have a shelf life in excess of 1.5 years.

In an example, a bowl of noodle soup may be formed by removing the cover from the container. Then, hot water may be added, cold water may be added and the resultant mixture heated, or the noodles can be added to hot water. The noodles may stay in the water for approximately 1.5 minutes, spices may be added, and the noodle soup may be enjoyed.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A method, comprising:
washing a raw vegetable;
slicing the raw vegetable into a vegetable sheet;
rolling the vegetable sheet into a vegetable roll, the vegetable roll comprising one or more vegetable sheet convolutions;
slicing the vegetable roll across a longitudinal axis of the vegetable roll into a one or more spiral vegetable noodles, each spiral vegetable noodle comprising one or more vegetable noodle coils;
drying the spiral vegetable noodles using a dryer to yield dried spiral vegetable noodles such that a nutritional value is substantially retained;
arranging the dried spiral vegetable noodles in a container; and
sealing the container.

2. The method of claim 1, further comprising, prior to drying the spiral vegetable noodles, placing the spiral vegetable noodles on a tray configured to fit within the dryer.

3. The method of claim 1, wherein washing the raw vegetable comprises spraying the raw vegetable using a high-pressure water sprayer and peeling a skin of the raw vegetable off of the raw vegetable.

4. The method of claim 1, further comprising arranging a seasoning sachet in the container.

5. The method of claim 1, wherein the vegetable sheet is rolled such that the vegetable roll is tightly rolled.

6. The method of claim 1, wherein the dryer comprises a freeze dryer, a dehydrator, a slow dryer, an oven, a sun dryer, or a fryer.

7. The method of claim 1, wherein the dryer comprises a freeze dryer and drying the spiral vegetable noodles comprises:
adjusting the freeze dryer to a cooling temperature, thereby freezing the spiral vegetable noodles; and
adjusting the freeze dryer to heat over an evaporating time to an evaporation temperature, thereby heating the spiral vegetable noodles.

8. The method of claim 7, wherein the evaporating time determined such that a moisture content of the spiral vegetable noodles is reduced to at most 5%.

9. The method of claim 7, wherein the evaporating time is 12 hours, wherein the cooling temperature is −4 degrees Fahrenheit, and wherein the evaporation temperature is 156 degrees Fahrenheit.

10. The method of claim 1, wherein the spiral vegetable noodles remain substantially intact during the drying step.

11. The method of claim 1, further comprising verifying a moisture content of the dried spiral vegetable noodles is at most 5%.

12. The method of claim 1, wherein at least one of the freeze-dried spiral vegetable noodles has a longitudinal thickness of approximately 1 mm, approximately 1.5 mm, approximately 2 mm, approximately 4 mm, or approximately 6.35 mm.

13. The method of claim 1, wherein at least one of the freeze-dried spiral vegetable noodles has a substantially circular, rectangular, elliptical, or oval cross-sectional shape.

14. The method of claim 1, wherein the freeze-dried spiral vegetable noodles are configured such that the nutritional value is substantially retained upon reconstitution.

15. A food product, comprising:
a container; and
a plurality of freeze-dried spiral vegetable noodles disposed in the container, each freeze-dried spiral vegetable noodle configured to retain a spiral shape, each freeze-dried spiral vegetable noodle comprising one or more vegetable noodle coils, wherein each freeze-dried spiral vegetable noodle substantially retains a nutritional value, wherein each freeze-dried spiral vegetable noodle comprises a root vegetable or a cruciferous vegetable.

16. The food product of claim 15, wherein at least one of the plurality of freeze-dried spiral vegetable noodles has a longitudinal thickness of approximately 1 mm, approximately 1.5 mm, approximately 2 mm, approximately 4 mm, or approximately 6.35 mm.

17. The food product of claim 15, wherein at least one of the plurality of freeze-dried spiral vegetable noodles has a radial noodle thickness of approximately 0.8 mm.

18. The food product of claim 15, wherein at least one of the plurality of freeze-dried spiral vegetable noodles comprises a portion of a carrot, a daikon, a parsnip, a zucchini, a yellow squash, a turnip, a beet, a butternut squash, a rutabaga, a zucchini, a cucumber, a broccoli stalk, a cauliflower stalk, a potato, or a pumpkin.

19. A method, comprising:
slicing a raw vegetable into a vegetable sheet;
rolling the vegetable sheet into a vegetable roll, the vegetable roll comprising one or more vegetable sheet convolutions;
slicing the vegetable roll across a longitudinal axis of the vegetable roll to yield a spiral vegetable noodle, the spiral vegetable noodle comprising one or more vegetable noodle coils; and
drying the spiral vegetable noodle such that a nutritional value is substantially retained.

20. The method of claim 19, further comprising arranging the spiral vegetable noodle in a container.
